(19) United States
(12) Patent Application Publication
(10) Pub. No.: US 2005/0275546 A1
(43) Pub. Date: Dec. 15, 2005

(54) Flow Sentry II toilet water saver

(76) Inventors: Edward Joseph McKenna, Dunedin, FL (US); Christopher Michael McKenna, Palm Harbor, FL (US)

Correspondence Address: EDWARD J. MCKENNA, 2388 JONES DRIVE, DUNEDIN, FL, 34698, US

(21) Appl. No.: 10/854,573

(22) Filed: May 26, 2004

(51) Int. Cl. G08B 21/00

(52) U.S. Cl. 340/605; 340/384.1

(57) ABSTRACT

FlowSentry II is an apparatus designed to save water in a conventional operating toilet. When the level of water in a toilet tank drops 1/8 of a inch (absent a normal flush) FlowSentry II alerts the user of the toilet, by way of an audible alarm, that the toilet is leaking water. FlowSentry II only determines that the level of water in the tank has dropped or risen (in an overflow situation), it cannot diagnose the cause of the drop or rise in water level (i.e. leaking flapper, faulty overflow tube, etc.). During the normal flush process the Flow Sentry II monitors the time it takes the tank to refill with water and determines if the supply valve has closed properly. If the water level fails to return to normal level in 90 seconds or tank continues to fill exceeding normal level, a continues audible alarm will sound until corrective action is taken or the 9V battery is exhausted.

### CROSS REFERENCE TO RELATED APPLICATIONS

We have been unable to find any published information in our Patent Search that concern inventions that relate to the invention presented in this application.

### BACKGROUND OF INVENTION

This invention is a water saving device that detects water movement in a toilet's water tank, and by way of an alarm system, signals the user when such movement is caused by a malfunction of one of the objects in the water tank. For example, when a toilet's flapper has failed, has a slow leak, or when the toilet's tank has an overflow situation, the FlowSentry II will alert the user that there is a problem. There have been several products designed to save water that concern the flapper, but they do not accomplish the features that will be described in this invention.

### SUMMARY OF INVENTION

A primary object of this invention is to provide a device that detects when water runs continually after the toilet is flushed. By doing so, the device assists the user in saving water. It also provides the user with a device with options that are not currently available.

An additional object is to be able to detect when water continues to run after the toilet is flushed and if the supply valve fails to close properly.

Another object is that the device will detect when water is leaving the tank when the toilet is not in use.

Another object is that the device has an automatic battery check.

Another object is that all components of the device function out of sight (completely enclosed in the toilet tank).

Another object is that the device can be installed in minutes with no tools required.

Another object is that the device is designed to be water and moisture proof.

Another object is that the device is low voltage.

Another object is that the device is inexpensive.

Another object is that the device requires minor installation adjustments as to location.

### BRIEF DESCRIPTION OF DRAWINGS

FIG. 1 is a diagrammatic perspective view of the FlowSentry II's Main Deck. The diagram demonstrates the positioning of the MOUNTING ARM, the ON DELAY RELAY, the ALARM, the BATTERY CONTACTS, the SUPPLY VALVE MONITOR CONTACTS (C-1R & C-2R), and the position of CONTACTS A-1, A-2, B-1, and B-2.

FIG. 2. is a diagrammatic perspective view of the FlowSentry II's Main Deck showing the Reed Relays A & B and the position of Float Assemblies A & B.

FIG. 3 is a diagrammatic perspective view of the Supply Valve Monitor. This diagram shows the position of Reed Relay C, Float Assembly C, the wiring to and from the Main Deck.

FIG. 4 is a diagrammatic perspective view of the FlowSentry mounted to the overflow tube. The diagram also demonstrates the positioning of the SUPPLY VALVE MONITOR, attached to the Main Deck of the FlowSentry II.

### DETAILED DESCRIPTION

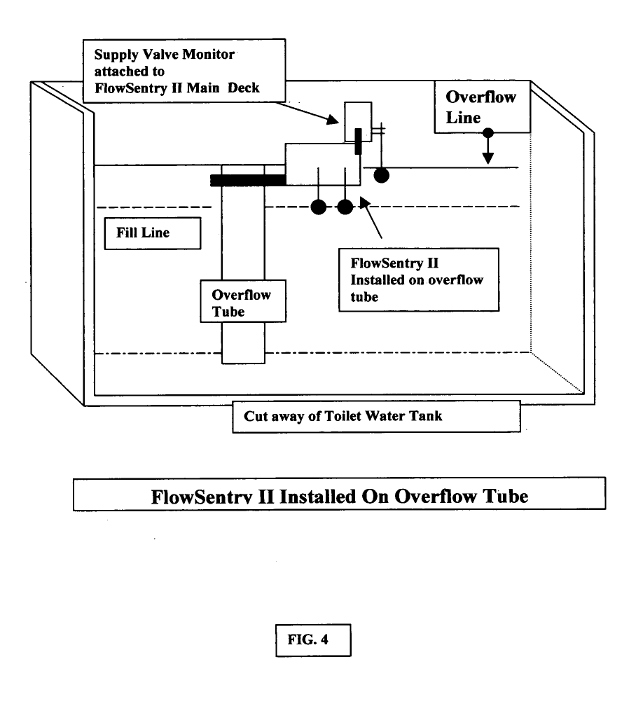

In the description of the drawings, similar reference characters will denote similar elements throughout the several views, the Figures illustrate the FlowSenty II apparatus for use in a toilet that will attach to the overflow tube (see FIG. 4).

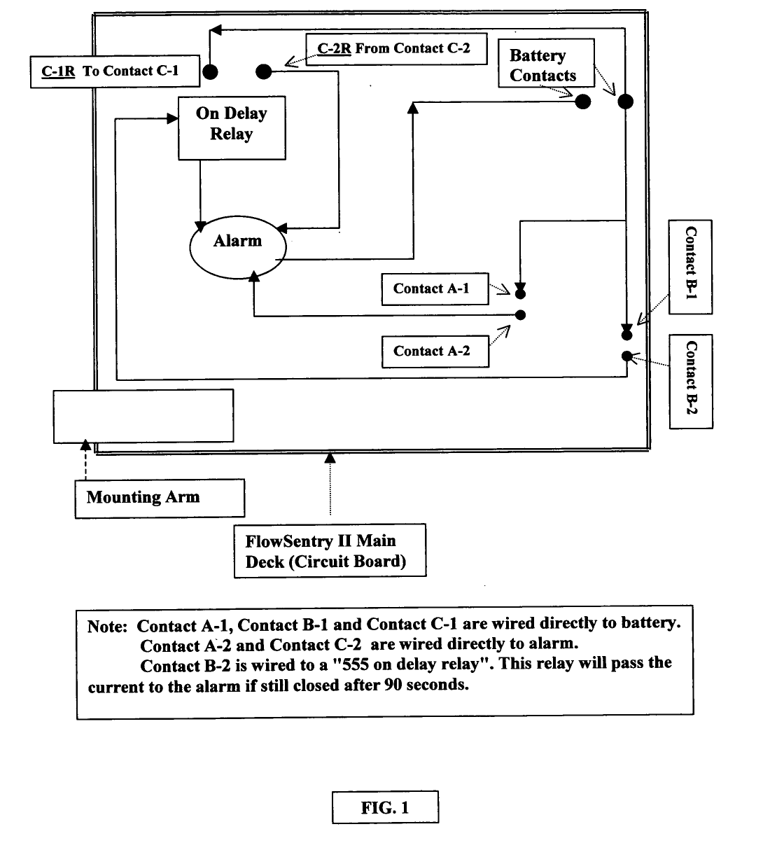

In the description of the drawings, the mounting arms will be noticed (see FIG. 1). The MOUNTING ARMS are stainless steel bands (½″× 1/16″×4½″). The band will have a ⅛″ hole centered ½″ from right side lengthwise and a ⅛″ hole centered 1″ from right side (lengthwise), to rivit board to arm. Additionally, each band will have a 3/16″ centered threaded hole ⅜″ from the left side (lengthwise) and a 3/16″ centered threaded hole 2 11/16″ from left side (lengthwise), to mount unit to the overflow tube with thumb-screws (wingnuts).

In the description of the drawings, the MAIN DECK will be noticed (see FIG. 1). The MAIN DECK is a standard 3½″×2″ circuit board. Attached to the circuit board (Main Deck), are the SUPPLY VALVE MONITOR CONTACTS, the BATTERY CONTACTS, the ON DELAY RELAY, the ALARM, the MOUNTING ARM, the BATTERY HOUSING (Not Shown—mounted on back of Main Deck).

In the description of the drawings, the wiring Schematic (FIG. 1) showing contacts C-1, B-1 and C-1R wired directly to the Battery. This drawing also shows contacts A-2 and C-2R wired to the Alarm and contact B-2 wired to the On Delay Relay.

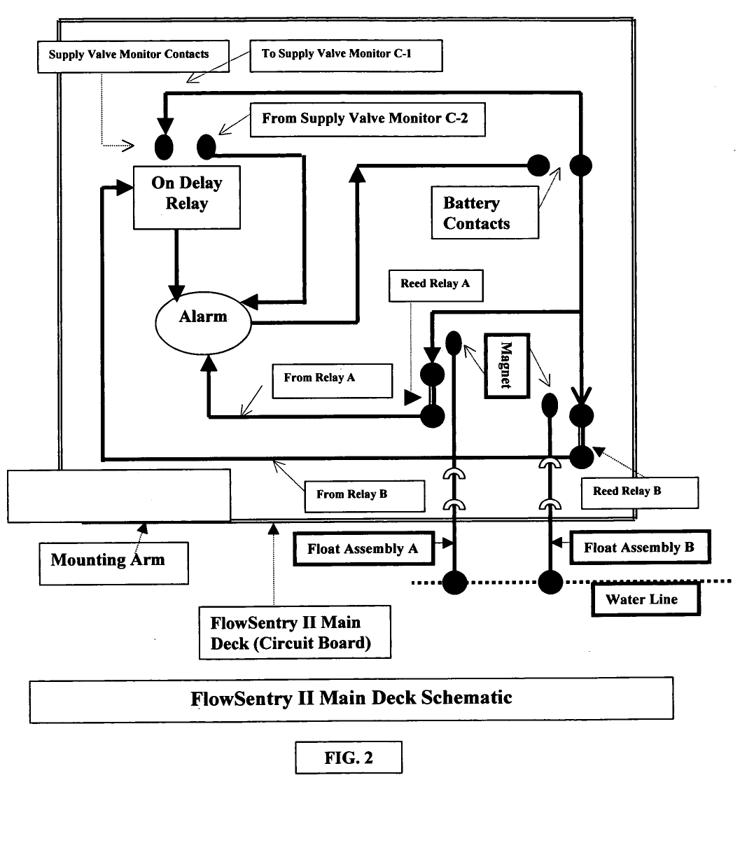

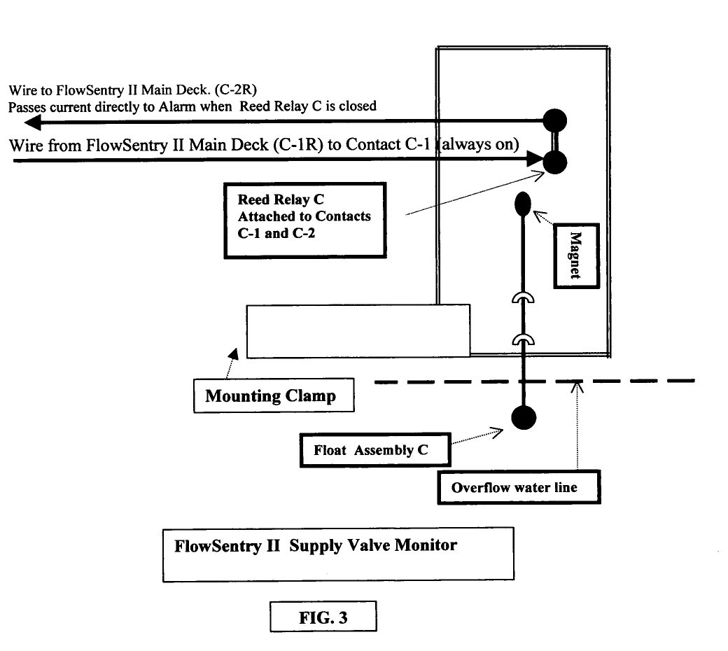

In the description of the drawings, Reed Relays A & B will be noticed, as well as Float Assemblies A & B. A Float Assembly consists of a small plastic rod with a small magnet attached to one end and a small float attached to the other end. Each assembly has two float guides. Neither the magnet nor the float will pass through the float guides. FlowSentry II has three Float Assemblies. Two Float Assemblies are positioned on the Main Deck (FIG. 2), while the third Float Assembly is positioned on the Supply Valve Monitor (FIG. 3).

In the description of the drawings, Reed Relay A will be noticed (see FIG. 2). Reed Relay A is soldered to Contacts A-1 and A-2. Reed Relay A is normally open.

In the description of the drawings, Reed Relay B will be noticed (see FIG. 2). Reed Relay B is soldered to Contacts B-1 and B-2. Reed Relay B is normally open.

In the description of the drawings, Float Assembly A will be noticed (see FIG. 2). In the event of a normal flush operation the float, rod and magnet will drop to its limit, stopped by the magnet attached to the rod. As the magnet in Float Assembly A passes Reed Relay A, the valve will close briefly causing the Alarm to sound briefly (Battery Check).

In the description of the drawings, Float Assembly B will be noticed (see FIG. 2). In the event of a normal flush operation the float, rod and magnet will drop to its limit, stopped by the magnet attached to the rod. The limit for this Float Assembly positions the magnet next to REED RELAY B. This position closes REED RELAY B sending current to the ON Delay Relay.

In the description of the drawings, Float Assembly A and Float Assembly B will be noticed (see FIG. 2). In the event of a normal flush operation, when the water in the tank returns to its normal operating level these float assembly rods will return to their normal position and Reed Relays A & B will be open. In the event the water does not return to the normal operating level within 90 seconds (flapper fails to close properly) the ON DELAY RELAY will activate the ALARM.

In the description of the drawings, Float Assembly A will be noticed (see FIG. 2). In the event of a drop in the level of water in the tank, absent a flush, the float rod in Float Assembly A will pass REED RELAY A much slower than during a normal flush operation. This action will cause REED RELAY A to remain closed sounding the Alarm for a longer period than a normal flush, alerting the toilet owner that there is a leak in the tank.

In the description of the drawings, FlowSentry II's Supply Valve Monitor will be noticed (see FIG. 3). This monitor is attached to the main deck by means of an alligator clip. This method of attachment allows for variables in the overflow line of a particular toilet.

In the description of the drawings, Reed Relay C will be noticed (see FIG. 3). Reed Relay C is soldered to Contacts C-1 and C-2. Contact C-1 is connected to MAIN DECK by means of a wire soldered connection from C-1 to C-1R (FIG. 2). Contact C-2 is connected to MAIN DECK by means of a wire soldered connection from C-2 to C-2R (FIG. 2). Reed Relay B is normally open.

In the description of the drawings, FLOAT ASSEMBLY C will be noticed (see FIG. 3). In the event water reaches the overflow line the magnet on the top of the float rod in Float Assembly C will close Reed Relay C and a continuous Alarm will sound, indicating that the toilet is malfunctioning.

1. The FlowSentry II is for use in a toilet of the type having a tank, a flush port, a valve seat (flapper), an overflow tube, a water supply source and a flush handle. Said apparatus is mounted on the overflow tube in the air space between the upper level of the water in the tank and the tank cover. The FlowSentry II, uses three magnetic floats that monitor the level of water in a tank and reports abnormalities by way of an audible alarm.

2. The FlowSentry II as described in claim 1, has three float rod assemblies (magnetic floats). Float rod assembly A, float rod assembly B and Float rod assembly C. A “Float Rod Assembly” consists of a small plastic rod. This plastic rod has a small float attached to one end and a small magnet attached to the other end. Each “Float Rod Assembly” has two float rod guides.

3. Float Rod Assembly A, as described in claim 2, detects the downward movement of water. When the level of water in the tanks drops ⅛″ an alarm will sound. During a normal flush this will be a short beep. In the event of a slow leak, the alarm will be longer depending on the extent of the leak. This assembly detects and reports the costly silent leak.

4. Float Rod Assembly A as described in claim 2, sounds a short alarm each time a toilet is flushed. This feature serves as a battery check.

5. Float Rod Assembly B, as described in claim 2, sends current to an on delay timer whenever the water level drops ½″. If this float rod assembly is not returned to its original position within 90 seconds (toilet flapper failed to close) a continues alarm will sound. This assembly detects and reports costly defective flapper situations.

6. Float Rod Assembly C, as described in claim 2, detects the presence of water above the normal operating level. If float rod assembly C is activated, suggesting a failed closure of the supply valve, a continues alarm will sound. This assembly detects and reports costly defective supply valve failures.

7. FlowSentry II requires no tools for installation. It is installed inside the tank and is not visible once the tank cover is replaced. It normally operates above the water level with a 9-volt battery. FlowSentry II, in general use, would save millions of gallons of drinking water annually.
